(19) United States
(12) Patent Application Publication
(10) Pub. No.: US 2021/0081891 A1
(43) Pub. Date: Mar. 18, 2021

(54) Systems and Methods for Tracking Beer Kegs and other Fluid Vessels

(71) Applicant: Altair Engineering, Inc., Troy, MI (US)

(72) Inventors: Joanna McLellan, Troy, MI (US); Aniket Hegde, Troy, MI (US); Jeffrey Hopkins, Troy, MI (US); Steven Fine, Troy, MI (US); John Ivey, Farmington Hills, MI (US); Rick Darling, Troy, MI (US); Brian Nickol, Macomb, MI (US)

(21) Appl. No.: 16/573,531

(22) Filed: Sep. 17, 2019

(51) Int. Cl. G06Q 10/08; G06F 1/3296; H04W 4/80; H04W 4/029; B67D 1/08

(52) U.S. Cl. CPC G06Q 10/0833; G06Q 10/087; G06F 1/3296; B67D 2001/0811; H04W 4/029; B67D 1/0801; H04W 4/80

(57) ABSTRACT

An example system for detecting a beer keg includes a transmitter assembly attached to the beer keg, a receiver assembly attached to a handle for attaching to the mouth of the beer keg, and a data processing apparatus in communication with the receiver assembly. The transmitter assembly includes a memory storing a unique identifier for the beer keg, a wireless transmitter for transmitting a wireless signal encoding the unique identifier, and a loop antenna positioned around a mouth of the beer keg. The receiver assembly includes a reader for reading the wireless signal from the transmitter beacon when the handle is attached to the mouth. The data processing is programmed to detect the unique identifier based on the wireless signal read by the reader.

### TECHNICAL FIELD

This description relates to tracking fluid vessels such as beer kegs.

### BACKGROUND

Fluid substances can be transported within fluid-tight vessels. For example, beer can be deposited into a beer keg at a brewery, and transported from one location (e.g., the brewery or a distributor) to another location (e.g., a restaurant).

Fluid substances also can be dispensed from vessels for use. For example, beer can be dispensed from a beer keg (e.g., using a keg coupler, tap, or other dispensing device) for consumption.

### SUMMARY

Systems and methods for tracking the contents, movement, and/or usage of fluid vessels (e.g., beer kegs) are described herein.

In an example implementation, a fluid vessel includes a mouth, from which the contents of the fluid vessel can be dispensed (e.g., using a keg coupler, tap, or other dispensing device). Further, a transmitter assembly is attached to a fluid vessel, which enables the fluid vessel to be wirelessly tracked. For example, the transmitter assembly broadcasts a wireless signal including a unique identifier (e.g., a sequence of information that identifies the fluid vessel and/or transmitter assembly, and distinguishes the fluid vessel and/or transmitter assembly from other fluids vessels or transmitter assemblies).

The transmitter signal is detected by a receiver assembly in proximity to the fluid vessel. The receiver assembly determines the unique identifier contained in the transmitter signal, and transmits the unique identifier to one or more other systems for further processing. As an example, the unique identifier can be provided to a remote database system that records the unique identifiers associated with one or more fluid vessels, the contents of those fluid vessels, the past locations of those fluid vessels, the current or last known locations of those fluid vessels, the usage of those fluid vessels, and other information regarding those fluid vessels. The remote database can update its records based on the information received from the receiver assembly, and provide users with up to date information regarding the fluid vessels.

Further, the transmitter assembly and the receiver assembly are configured to enhance the reliability and accuracy of the tracking process. For example, the receiver assembly is configured such that it can be positioned on or integrated into the dispensing device (e.g., positioned on or integrated into the handle of a keg coupler or tap). Further, the transmitter assembly is configured such that it can be positioned on or integrated into the fluid vessel at a location near the mouth of the fluid vessel. Accordingly, during use of the dispensing device (e.g., when the keg coupler or tap is inserted into the beer keg), the transmitter assembly and the receiver assembly are in close proximity to one another. This close proximity facilitates detection of the transmitter signal by the receiver assembly, and enables the receiver assembly to distinguish the transmitter assembly from other transmitter assemblies that may be in the area (e.g., transmitter assemblies attached to other fluid vessels that are not presently connected to the dispensing device).

The implementations described herein can provide a variety of benefits. For example, implementations of this system can be used to track the contents, movement, and/or usage of fluid vessels throughout the lifecycle of the fluid vessel (e.g., from production, to one or more cycles of filling, distribution, and use by a consumer, and to eventual disposal). This enables users to manage an inventory of fluid vessels and their contents more accurately and more effectively (e.g., compared to keeping manual records). Further, implementations of this system enable users to track fluid vessels in an intuitive manner, without requiring that he deviate substantially from his usual workflow in using a fluid vessel.

In an aspect, a system for detecting a beer keg includes a transmitter assembly attached to the beer keg, a receiver assembly attached to a handle for attaching to the mouth of the beer keg, and a data processing apparatus in communication with the receiver assembly. The transmitter assembly includes a memory storing a unique identifier for the beer keg, a wireless transmitter for transmitting a wireless signal encoding the unique identifier, and a loop antenna positioned around a mouth of the beer keg. The receiver assembly includes a reader for reading the wireless signal from the transmitter beacon when the handle is attached to the mouth. The data processing apparatus is programmed to detect the unique identifier based on the wireless signal read by the reader.

Implementations of this aspect can include one or more of the following features.

In some implementations, the handle can be rotatable about the mouth and the transmitter assembly can be configured so that the wireless signal has a substantially constant signal strength for all positions of the reader in the handle about the mouth.

In some implementations, the loop antenna can be a circular loop.

In some implementations, the circular loop can be centered on the mouth of the keg.

In some implementations, the loop antenna can have a length that is an integer multiple of a wavelength of the wireless signal.

In some implementations, the system can further include a protective cover sealing the transmitter assembly against an outer surface of the keg.

In some implementations, the transmitter beacon can be spaced apart from the loop antenna.

In some implementations, the wireless signal can be a Bluetooth signal.

In some implementations, the receiver assembly can further include a wireless transmitter in wireless communication with the data processing apparatus.

In another aspect, a transmitter assembly includes an annular support structure, a wireless beacon secured to the support structure, and a loop antenna loop secured to the support structure. The apparatus is configured to attach to a fluid vessel.

Implementations of this aspect can include one or more of the following features.

In some implementations, the annular support structure can define a central aperture. The loop antenna can encircles the central aperture.

In some implementations, the apparatus can be configured to attach to the fluid vessel such that the central aperture encircles a mouth of the fluid vessel.

In some implementations, the wireless beacon can be configured to transmit a wireless signal including a unique identifier associated with the apparatus.

In some implementations, the wireless beacon can be configured to transmit the wireless signal according to a wavelength of transmission.

In some implementations, the wavelength of transmission can correspond to a Bluetooth wireless transmission standard.

In some implementations, the wavelength of transmission can be 12.5 cm.

In some implementations, the loop antenna can define a substantially circular path.

In some implementations, a circumference of the circular path can be substantially an integer multiple of the wavelength of transmission.

In some implementations, the wireless beacon can include a beacon antenna. The antenna can be separate and distinct from the loop antenna.

In some implementations, there can be an absence of a conductive trace interconnecting the beacon antenna and the loop antenna.

In some implementations, a distance between the beacon antenna and the loop antenna can be between 0 and 2 cm.

In some implementations, the fluid vessel can be a beer keg.

In some implementations, the apparatus can be integrated into the fluid vessel.

In another aspect, a method includes detecting, using a receiver assembly, one or more wireless signals from one or more transmitter assemblies. Each transmitter assembly is attached to a respective fluid vessel, and each wireless signal includes a respective unique identifier associated with a respective transmitter assembly and a respective fluid vessel. The method also includes identifying a first wireless signal having a highest signal strength from among the one or more wireless signals. The method also includes determining that the first wireless signal satisfies one or more selection criteria, and responsive to determining that the first wireless signal satisfies the one or more selection criteria, transmitting the unique identifier of the first wireless signal to a remote device.

Implementations of this aspect can include one or more of the following features.

In some implementations, the one or more selection criteria can include a requirement that the first wireless signal be greater than or equal to a threshold signal strength.

In some implementations, the receiver assembly can be attached to a dispenser for dispensing a substance from at least one of the fluid vessels.

In some implementations, the one or more wireless signals can be detected concurrently to a dispensing of the substance from a first fluid vessel by the dispenser.

In some implementations, the method can further include awakening the receiver assembly from a low power mode concurrently to the dispensing of the substance from the first fluid vessel by the dispenser.

In some implementations, the method can further include generating usage data indicating that the substance has been dispensed from the first fluid vessel by the dispenser, and transmitting the usage data to the remote device.

In some implementations, the usage data can include location information indicating a location of the first fluid vessel during the dispensing of the substance from the first fluid vessel by the dispenser.

In some implementations, the usage data can include temporal information indicating a time that the substance was dispensed from the first fluid vessel by the dispenser.

In some implementations, the usage data can include volume information indicating a volume of the substance dispensed from the first fluid vessel by the dispenser.

In some implementations, the unique identifier of the first wireless signal can be transmitted to a remote device via a network gateway in proximity to the receiver assembly and the dispenser.

In some implementations, one or more of the fluid vessels can be beer kegs.

The details of one or more embodiments are set forth in the accompanying drawings and the description below. Other features and advantages will be apparent from the description and drawings, and from the claims.

### BRIEF DESCRIPTION OF THE DRAWINGS

FIG. 1 is a diagram of an example system for tracking fluid vessels.

FIG. 2 is a diagram of an example tracking platform.

FIG. 3 is a diagram of an example transmitter assembly.

FIGS. 4 and 5 are diagrams of an example transmitter assembly, fluid vessel, and dispensing device.

FIG. 6 is a flow chart diagram of an example process for tracking fluid vessels.

FIG. 7 is a diagram of an example computer system.

### DETAILED DESCRIPTION

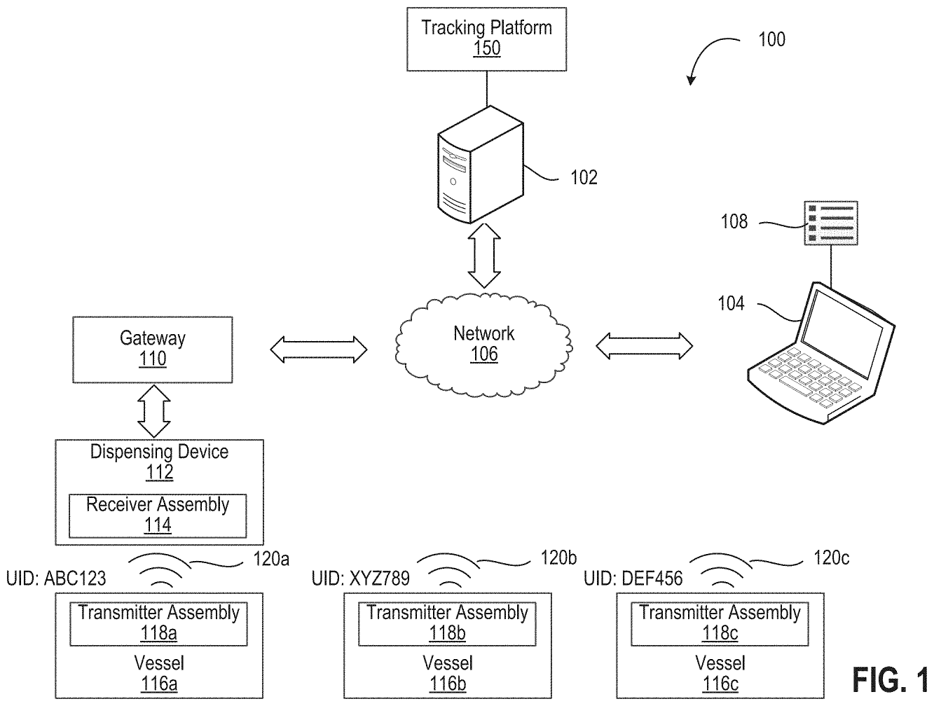

An example system 100 for tracking fluid vessels is shown in FIG. 1. The system 100 includes a tracking platform 150 maintained on a server computer system 102 that includes one or more server computers.

The server computer system 102 is illustrated as a respective single component. However, in practice, it can be implemented on one or more computing devices (e.g., each computing device including at least one processor such as a microprocessor or microcontroller). A server computer system 102 can be, for instance, a single computing device that is connected to the network 106, and the tracking platform 150 can be maintained and operated on the single computing device. In some implementations, the server computer system 102 can include multiple computing devices that are connected to the network 106, and the tracking platform 150 can be maintained and operated on some or all of the computing devices. For instance, the server computer system 102 can include several computing devices, and the tracking platform 150 can be distributive on one or more of these computing devices. In some implementations, the server computer system 102 need not be located locally to the rest of the system 100, and portions of a server computer system 102 can be located in one or more remote physical locations.

The server computer system 102 is communicatively connected to one or more client computer system 104 using the network 106. Each client computer system 104 includes a respective user interface 108. Users interact with the user interfaces 108 to view data (e.g., data on the server computer system 102 and the platform 150, and/or data on other the client computer systems 104). Users also interact with the user interfaces 108 to transmit data to other devices (e.g., to the server computer system 102 and the platform 150, and/or to the other client computer systems). Users interact with the user interfaces 108 to issue commands (e.g., to the server system 102 and the platform 150, and/or to the other client computer systems 104). Commands can be, for example, any user instruction to the server computer system 102 and/or to the client computer systems 104. In some implementations, a user can install a software application onto a client computer system 104 in order to facilitate performance of these tasks.

A client computer system 104 can be any electronic device that is used by a user to view, process, transmit and receive data. Examples of the client computer systems 104 include computers (such as desktop computers, notebook computers, server systems, etc.), mobile computing devices (such as cellular phones, smartphones, tablets, personal data assistants, notebook computers with networking capability), and other computing devices capable of transmitting and receiving data from the network 106. The client computer systems 104 can include devices that operate using one or more operating system (e.g., Microsoft Windows, Apple OS X, Linux, Unix, Android, Apple iOS, etc.) and/or architectures (e.g., x86, PowerPC, ARM, etc.) In some implementations, one or more of the client computer systems 104 need not be located locally with respect to the rest of the system 100, and one or more of the client computer systems 104 can be located in one or more remote physical locations. In some implementations, the client computer systems 104 can communicate with a geo-positioning system (e.g., a global positioning system [GPS], Wi-Fi triangular system, and so forth) in order to determine its geographical location.

The network 106 can be any communications network through which data can be transferred and shared. For example, the network 106 can be a local area network (LAN) or a wide-area network (WAN), such as the Internet. The network 106 can be implemented using various networking interfaces, for instance wireless networking interfaces (such as Wi-Fi, Bluetooth, or infrared) or wired networking interfaces (such as Ethernet or serial connection). The network 106 also can include combinations of more than one network, and can be implemented using one or more networking interfaces.

The server computer system 102 is also communicatively connected to a gateway 110 via the network 106. The gateway 110 is a networking system that routes communications from one or more devices (e.g., devices local to the gateway 110) to the network 106. As an example, the gateway 110 can include one or more network routers, wired or wireless access points, switches, servers, or other devices for routing communications.

The system 100 also includes one or more dispensing devices 112, each having a respective receiver assembly 114. The dispensing devices 112 are configured to dispense substances from fluid vessels 116a-116 (e.g., fluid-tight containers configured to store fluid substances, such as beer kegs). As an example, the dispensing devices 112 can be beer taps that are configured to couple to a mouth of a beer keg, and selectively dispense beer from the beer keg (e.g., when a user manipulates a handle on the beer tap).

Each fluid vessel 116a-116c includes a respective transmitter assembly 118a-118c. In some implementations, the transmitter assemblies 118a-118c can be discrete components that are physically secured to their respective fluid vessels 116a-116c (e.g., adhered, welded, nailed, bolted, etc. after the fluid vessels are manufactured). This can be useful, for example, in retrofitting fluid vessels that were originally manufactured without transmitter assemblies. In some implementations, the transmitter assemblies 118a-118c can be integrated directly into their respective fluid vessels 116a-116c (e.g., incorporated into the fluid vessels as a part of the manufacturing process).

The transmitter assemblies 118a-118c enable wireless tracking of each the fluid vessels 116a-116c. For example, the transmitter assemblies 118a-118c broadcast respective wireless transmitter signals 120a-120c, each indicating a unique identifier (e.g., a sequence of information that identifies the respective fluid vessel and/or transmitter assembly, and distinguishes that fluid vessel and/or transmitter assembly from other fluids vessels or transmitter assemblies). As an example, each transmitter assembly 118a-118c can include a respective wireless transceiver or radio configured to transmit a wireless transmitter signal according to a particular transmission standard or protocol. In some implementations, each transmitter assembly 118a-118c can be configured to transmit wireless signals according to a Bluetooth communications standard (e.g., the Bluetooth Low Energy standard).

Some or all of the transmitter signal 120a-120c are detected by the receiver assembly 114. As an example, the receiver assembly 114 can include a reader, such as a wireless transceiver or radio, configured to detect wireless signals transmitted according to a particular transmission standard or protocol. In some implementations, the receiver assembly 114 can be configured to detect wireless signals transmitted according to a Bluetooth communications standard (e.g., the Bluetooth Low Energy standard).

The receiver assembly 114 determines the unique identifier contained in the transmitter signal, and transmits the unique identifier to one or more other systems for further processing. As an example, the unique identifier can be transmitted to the tracking platform 150 via the gateway 110 and the network 106. In some implementations, the receiver assembly 114 can also transmit additional information, such as the location of the receiver assembly 114, the time at which the transmitter signal was detected, and/or an identity of the dispensing device (e.g., a unique identifier associated with the dispensing device). In some implementations, the receiver assembly 114 can also transmit information describing the context in which the transmitter signal was detected. For example, the receiver assembly 114 can transmit information indicating that the transmitter signal was detected during a dispensing of fluid from a vessel, the duration that the fluid was dispensed, and/or an amount or volume of the fluid that was dispensed.

The tracking platform 150 facilitates tracking of one or more fluid vessels. For example, the tracking platform 150 can record the unique identifiers associated with one or more fluid vessels, the contents of those fluid vessels, the past locations of those fluid vessels, the current or last known locations of those fluid vessels, the usage of those fluid vessels, and other information regarding those fluid vessels. The tracking platform 150 can update its records based on the information received from the receiver assembly 114, and provide users with up to date information regarding the fluid vessels. For example, users of the client computer systems 104 can access the records maintained on the tracking platform 150 to manage an inventory of fluid vessels.

In an example usage of the system 100, a fluid vessel is filled at a point of origin (e.g., a brewery). Further, at the point of origin, a receiver assembly detects a transmitter signal broadcast by a transmitter assembly positioned on the fluid vessel, and determines the identity of the fluid vessel and/or the transmitter assembly based on the transmitter signal (e.g., a unique identifier associated with the transmitter assembly and/or the fluid vessel). This information is transmitted to the tracking platform (e.g., via a gateway and network) for processing. Based on this information, the tracking platform generates a record for the fluid vessel and/or transmitter. Further, the record is populated with information regarding the fluid vessel and/or the transmitter assembly (e.g., the contents of the fluid vessel, the location of the fluid vessel, the time at which the fluid vessel was filled, the time at which the location of the fluid vessel was determined, the time of departure of the fluid vessel from the point of origin, the intended recipient of the fluid vessel, etc.).

The fluid vessel is subsequently transported from the point of origin to an intermediate location (e.g., a distributor) for distribution. When the fluid vessel is located at the intermediate location (e.g., upon arrival, during storage, and/or upon departure from the intermediate location), a receiver assembly detects the transmitter signal broadcast by the transmitter assembly positioned on the fluid vessel, and determines the identity of the fluid vessel and/or the transmitter assembly based on the transmitter signal. This information is transmitted to the tracking platform (e.g., via a gateway and network) for processing. Based on this information, the tracking platform updates the record for the fluid vessel and/or transmitter with additional information regarding the fluid vessel and/or the transmitter assembly (e.g., the location of the fluid vessel, the time at which the location of the fluid vessel was determined, the arrival time of the fluid vessel at the intermediate location, the departure time of the fluid vessel from the intermediate location, the intended recipient of the fluid vessel, etc.). In some implementations, the fluid vessel can be transported to one or more intermediate locations prior to arriving at its destination location.

The fluid vessel is subsequently transported to its destination location (e.g., a bar, restaurant, retailer, etc.) for use. In some cases, the fluid vessel may be stored for a period of time prior to use (e.g., in a cellar, refrigerator, storage room, etc.). In some cases, the fluid vessel can be used immediately upon receipt.

During use of the fluid vessel, a dispensing device (e.g., a beer coupler, tap, etc.) is inserted into the fluid vessel. As described herein, the dispensing device includes a receiver assembly that detects the transmitter signal broadcast by the transmitter assembly positioned on the fluid vessel, and determines the identity of the fluid vessel and/or the transmitter assembly based on the transmitter signal. This information is transmitted to the tracking platform (e.g., via a gateway and network) for processing. Based on this information, the tracking platform updates the record for the fluid vessel and/or transmitter with additional information regarding the fluid vessel and/or the transmitter assembly (e.g., the location of the fluid vessel, the time at which the location of the fluid vessel was determined, the time at which the fluid vessel was tapped for use, the number of times that substances were dispensed from the fluid vessel, the volume of substance that was dispensed from the fluid vessel, the times at which substances were dispensed, etc.).

After use, the fluid vessel is subsequently transported back to the point of origin (e.g., through one or more intermediate locations, or directly to the point of origin). At each location, a receiver assembly detects the transmitter signal broadcast by the transmitter assembly positioned on the fluid vessel, and determines the identity of the fluid vessel and/or the transmitter assembly based on the transmitter signal. This information is transmitted to the tracking platform (e.g., via a gateway and network) for processing. Based on this information, the tracking platform updates the record for the fluid vessel and/or transmitter with additional information regarding the fluid vessel and/or the transmitter assembly (e.g., the location of the fluid vessel, the time at which the location of the fluid vessel was determined, the arrival time of the fluid vessel at the intermediate location, the departure time of the fluid vessel from the intermediate location, the intended recipient of the fluid vessel, etc.).

At the point of origin, the fluid vessel is cleaned, refilled, and redistributed for use. The tracking process described herein can be repeated one or more times during the life of the fluid vessel. For example, the tracking process can be performed for each use cycle of the fluid vessel, from filling, to distribution, to use, and to return).

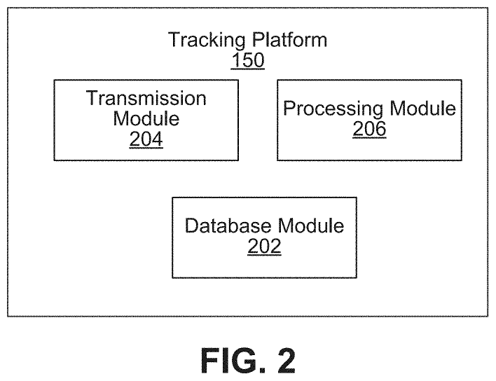

FIG. 2 shows various aspects of the tracking platform 150. The tracking platform 150 includes several modules that perform particular functions related to the operation of the system 100. For example, the tracking platform 150 includes a database module 202, a transmission module 204, and a processing module 206.

The database module 202 stores data regarding the operation of the system 100. For example, the database module 202 can store information regarding each of the fluid vessels 116a-116c (e.g., unique identifiers associated with the fluid vessels, the contents of the fluid vessels, the past locations of the fluid vessels, the current or last known locations of the fluid vessel, the usage of the fluid vessel, and other information regarding the fluid vessels). In some implementations, some or all of the data can be manually entered or updated (e.g., by a system administrator, a record keeper associated with a distributor, etc.). In some implementations, some or all of the data can be automatically entered or updated (e.g., by an automated data collection system).

In some implementations, the data can be updated using information transmitted by the dispensing device 112. For example, based on information transmitted by the dispensing device 112, the database module 202 can update its records to reflect that a particular fluid vessel was detected at a particular location and at a particular time, and used in a particular way (e.g., a particular amount of fluid was dispensed from the fluid vessel). These records can be retrieved by users (e.g., via the client computer systems 104) to manage an inventory of fluid vessels.

The transmission module 204 allows for the transmission of data to and from the tracking platform 150. For example, the transmission module 204 can be communicatively connected to the network 106, such that it can transmit and receive data to the client computer systems 104, the gateway 10, and/or the receiver assembly 114 via the network 106. As an example, information transmitted by the receiver assembly 114 can be received by the tracking platform 150 via the transmission module 204. This information can then be processed (e.g., using the processing module 206) and/or stored (e.g., using the database module 202). As another example, information from the tracking platform 150 (e.g., information stored on the database module 202) can be transmitted to the client computer systems 104 through transmission module 204.

The processing module 206 processes data stored or otherwise accessible to the tracking platform 150. For instance, the processing module 206 can execute automated or user-initiated processes that manipulate data pertaining to one or more fluid vessels. As an example, the processing module 206 can generate and transmit database queries to database module 202 to retrieve, modify, and/or delete data stored on the database module 202. As another example, the processing module 206 can generate and execute the database queries directly (e.g., the processing module 206 can execute the database queries to directly retrieve, modify, and/or delete data stored in the database module 202). Further, the processing module 206 can process data that is received from the transmission module 204. Likewise, processed data from the processing module 206 can be stored on the database module 202 (e.g., using one or more database queries) and/or sent to the transmission module 204 for transmission to other devices.

In some cases, the database module 202 and/or the processing module 206 can process data stored in the database module 202 in accordance with one or more data processing rules. These data processing rules can specify particular operations that are performed with respect to the data stored by the database module 202 based on particular conditions, criteria, and/or factors. In some cases, data that is processed in accordance with these rules can be rendered more useful to a user and/or can be stored more efficiently by the tracking platform 150. As an example, the data processing rules can specify how certain records can be accessed and/or modified based on a user's instructions and/or information received from the receiver assembly 114. In some cases, the data processing rules can be stored by the processing module 206 (e.g., so that the processing module 206 can directly access the processing rules). In some cases, the data processing rules can be stored by the database module 202.

Referring back to FIG. 1, the receiver assembly 114 and the transmitter assemblies 118a-118c are configured to enhance the reliability and accuracy of the tracking process. For example, the receiver assembly 114 is configured such that it can be positioned on or integrated into the dispensing device 112 (e.g., positioned on or integrated into the handle of a beer tap). Further, the transmitter assemblies 118a-118c are configured such that they can be positioned on or integrated into their respective fluid vessel 116a-116c, each at location near the mouth of a respective fluid vessel. Accordingly, during use of the dispensing device 112 in conjunction with a particular fluid vessel (e.g., the fluid vessel 116a), the receiver assembly 114 and a corresponding transmitter assembly 118a are in close proximity to one another. This close proximity facilitates detection of the transmitter signal 120a by the receiver assembly 114, and enables the receiver assembly 114 to distinguish the transmitter assembly 118a from other transmitter assemblies that may be in the area (e.g., the transmitter assemblies 118b and 118c attached to the other fluid vessels 116b and 116c that are not presently connected to the dispensing device 112).

The implementations described herein can provide a variety of benefits. For example, implementations of this system can be used to track the contents, movement, and/or usage of fluid vessels throughout the lifecycle of the fluid vessel (e.g., from production, to one or more cycles of filling, distribution, and use by a consumer, and to eventual disposal). This enables users to manage an inventory of fluid vessels and their contents more accurately and more effectively (e.g., compared to keeping manual records). Further, implementations of this system enable users to track fluid vessels in an intuitive manner, without requiring that he deviate substantially from his usual workflow in using a fluid vessel.

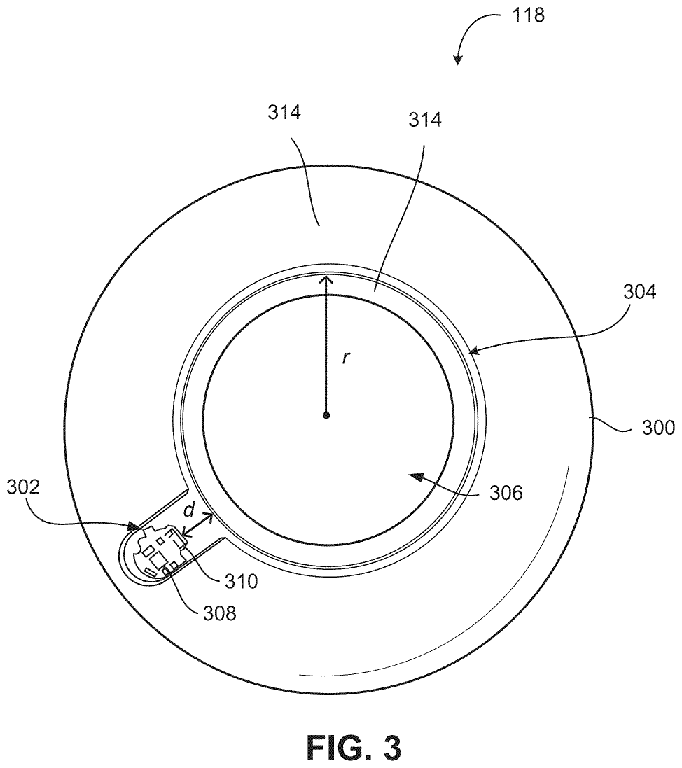

An example transmitter assembly 118 is shown in FIG. 3. The transmitter assembly 118 includes a support structure 300, a wireless beacon 302, and a loop antenna 304.

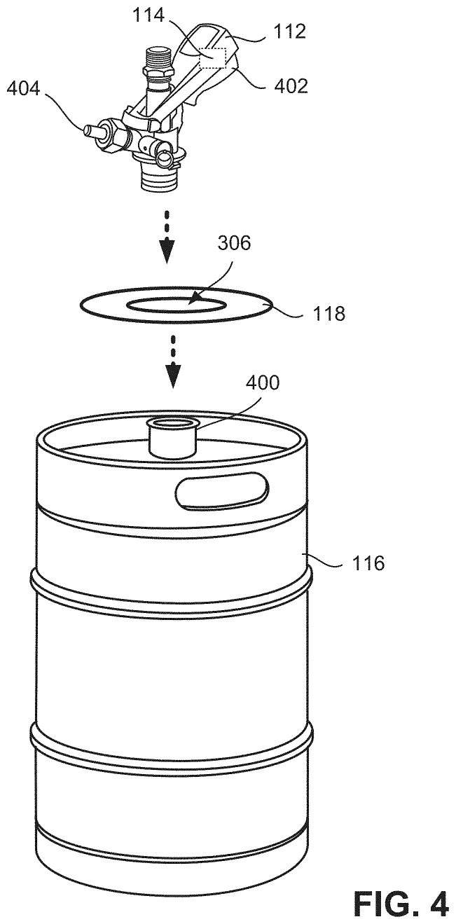

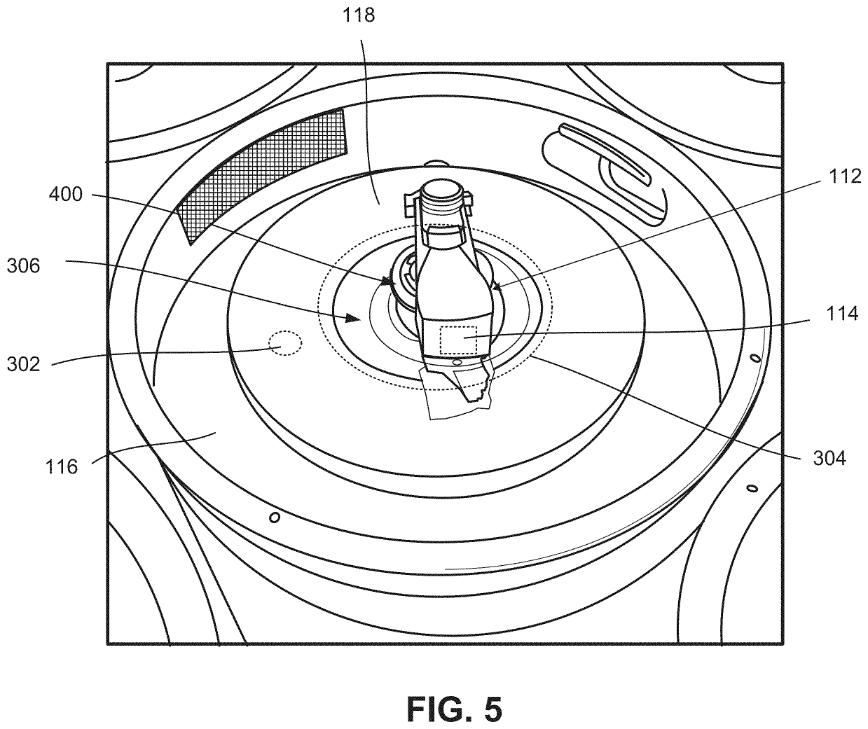

The support structure 300 provides structural support for the transmitter assembly 118. In the example shown in FIG. 3, the support structure 300 has a circular cross-section and defines a circular central aperture 306. This configuration enables the transmitter assembly 118 to be secured to a fluid vessel such it can be readily detected by the receiver assembly 114 during use. For example, as shown in FIGS. 4 and 5, the transmitter assembly 118 can be positioned on a top surface of the fluid vessel 116, such that the aperture 306 encircles the mouth 400 of the fluid vessel 116. The dispensing device 112 can be inserted into the mouth 400 of the fluid vessel 116 without interference by the transmitter assembly 118.

The support structure 300 can be constructed using one or more non-conductive or substantially non-conductive materials. Further, the support structure 300 can be constructed of one or more materials that are resistant of corrosion, exposure to heat and cold, exposure to water, and other extreme environmental conditions. As an example, the support structure 300 can be constructed, at least in part, using a nylon (e.g., Nylon 66).

Referring back to FIG. 3, the transmitter assembly 118 also includes a wireless beacon 302 affixed to the support structure 300. The wireless beacon 302 is configured to broadcast wireless transmitter signals indicating a unique identifier associated with the transmitter assembly 118 and/or the fluid vessel 116. As an example, the wireless beacon 302 can transmit a unique identifier, such as sequence of information (e.g., an alphanumeric sequence) that identifies the fluid vessel and/or transmitter assembly, and distinguishes that fluid vessel and/or transmitter assembly from other fluids vessels or transmitter assemblies.

The wireless beacon 302 includes one or more wireless transceivers or radios 308 and one or more antennas 310 configured to transmit a wireless transmitter signal according to a particular transmission standard or protocol (e.g., a Bluetooth communications standard). In some implementations, the antennas 310 are trace antennas (e.g., strips of conductive materials deposited, adhered, or otherwise disposed on a substrate, such as a printed circuit board). The antennas 310 are coupled to the wireless transceivers or radios 308 via a direct electrical connection (e.g., one or more conductive wires or traces extending directly between them).

The transmitter assembly 118 also includes a loop antenna 304 affixed to the support structure 300. In the example shown in FIG. 3, the loop antenna 304 defines a circular path and encircles the aperture 306 (e.g., along a lip 312 recessed from the outer surface 314 of the support structure 300). This is beneficial, as it electrically isolates the loop antenna 304 from the fluid vessel 116 (which may be electrically conductive). For example, when the transmitter assembly 118 is positioned on the fluid vessel 116 such that the outer surface 314 contacts the fluid vessel 116, the loop antenna 304 does not directly contact the fluid vessel 116.

The loop antenna has a radius of r. Further, the loop antenna is separated from the antennas 310 by a distance d (e.g., the minimal distance between any portion of the antenna 310 and any portion of the loop antenna 304 is d). In some implementations, the distance d can be between 0 and 2 cm (e.g., greater than 0, and less than 2 cm). Further, the loop antenna 304 is not coupled to the wireless beacon 302 via a direct electrical connection. For example, there is an absence of conductive wires or traces extending directly from the loop antenna 304 and the wireless beacon 302 (e.g., the loop antenna 304 and wireless beacon 302 are “air gapped” with respect to one another).

The loop antenna 304 amplifies the wireless transmitter signal transmitted by the wireless beacon 302 through electromagnetic induction. Further, due to the position of the loop antenna on the support structure 300, the amplified transmitter signal propagates in a more symmetric manner with respect the transmitter assembly 118 (e.g., compared to the transmitter signal that would be transmitted using the wireless beacon 302 alone). For example, as the loop antenna is centrally located on the wireless beacon 302 (e.g., encircling the central aperture 306), the amplified transmitter signal effectively propagates from transmitter assembly from the center or substantially the center of the transmitter assembly 118.

This is beneficial, as the dispensing device 112 and its receiver assembly 114 may not be positioned directly over the wireless beacon 302 during use. For example, as shown in FIG. 5, the handle of the dispensing device 112 can freely pivot with respect to the mouth 400 of the fluid vessel 116 (e.g., in a 360° arc), such that the receiver assembly 114 and wireless beacon 302 do not always align. However, due to the position of the loop antenna 304, the amplified transmitter signal effectively propagates from the center or substantively the center of the transmitter assembly 118. Thus, the detected transmitter signal has a substantially constant signal strength for all positions of the receiver assembly about the mouth of the fluid vessel, and the amplified transmitter signal can be readily detected by the receiver assembly 114, regardless of the position of the receiver assembly 114 relative to the wireless beacon 302.

In some implementations, the length of the loop antenna 304 (e.g., the circumference of its circular path) can depend on the characteristics of the transmitter signal. For instance, the loop antenna can have a length that is an integer multiple of a wavelength of the wireless signal (e.g., the same as the wavelength of the wireless signal, twice the wavelength of the wireless signal, three times the wavelength of the wireless signal, etc.). This is beneficial, for example, as it improves the transmission characteristics of the loop antenna 304 (e.g., due to electromagnetic resonance), and enables the transmitted transmitter signals to be detected more easily by the receiver assembly 114. In some implementations, the loop antenna can have a length that is an integer multiple of a wavelength of the wireless signal, within a certain tolerance range (e.g., ±5%, ±10%, ±15%, or within some other tolerance range).

As an example, if the transmitter signal is transmitted according to a Bluetooth communications standard (e.g., corresponding to a wavelength of 12.5 cm), the length of the loop antenna 304 can be 12.5 cm, 25 cm, 37.5 cm, etc. In some implementations, a length of 25 cm may be particularly advantageous (e.g., when transmitting transmitter signals according to the Bluetooth Low Energy standard in connection with a standard half barrel beer keg). However, although an example wavelength and example lengths of the loop antenna are described herein, these are merely illustrative examples. In practice, a transmitter assembly can transmit signals according to any wavelength, and the length of its loop antenna can be selected based on that wavelength.

Although the wireless beacon 302 and loop antenna are 304 exposed in the example shown FIG. 3, this need not be on the case. For example, in some implementations, the wireless beacon 302 and/or the loop antenna 304 can be covered by a cover structure (e.g., an annular disc having similar dimensions as the support structure 300), a potting compound, and/or a plug.

In some implementations, the receiver assembly 114 can be selectively activated during use of the dispensing device 112, and deactivated when the dispensing device 112 is not being used. For example, the receiver assembly 114 can be operated according to a low power state (e.g., a “sleep state”). When a user is actively dispensing fluid from a fluid container, the receiver assembly 114 can transition into a normal power state (e.g., an “awake state”) and actively detect transmitter signals. When the user discontinues dispensing, the receiver assembly 114 can transition back into the low power state. In some implementations, the receiver assembly 114 can transition back into the low power state immediately upon the dispensing being discontinued. In some implementations, the receiver assembly 114 can transition back into the low power state at a different time (e.g., after a particular amount of time has passed since dispensing was discontinued, after the receiver assembly 114 has completed detecting transmitter signals for a particular period of time, after the receiver assembly 114 has transmitted information regarding the detected transmitter signals to a remote device, etc.).

In some implementations, the receiver assembly 114 can be activated using the same mechanism of the dispensing device 112 that is used to dispense fluid. For example, referring to FIG. 4, the dispensing device 112 can include a handle 402 (e.g., a squeezable handle) that, when manipulated, causes fluid to be drawn out of the fluid vessel 116 through its mouth 400 and out of a spout 404. The receiver assembly 114 also can be coupled to the handle 402, such that it is selectively activated when the handle 402 is manipulated. This is beneficial, for example, as it enables users to track fluid vessels in an intuitive manner, without requiring that he deviate substantially from his usual workflow in using a fluid. For example, a user need not operate the dispensing device 112 differently, or conduct any additional steps as a part of the tracking process. Further, this reduces the energy consumption of the receiver assembly 114, as it is selectively activated in response to certain events rather than continuously operated.

In some use cases, a user may place several fluid vessels in close proximity to one another. If the fluid vessels are sufficiently close, a receiver assembly that is aligned with the transmitter assembly of one fluid vessel might nevertheless detect transmitter signals transmitted by the other fluid vessels. For example, referring to FIG. 1, although the dispensing device 112 is attached to the fluid vessel 116a, if the other fluid vessels 116b and 116c are sufficiently close, the receiver assembly 114 may detect all three transmitter signals 120a-120c.

To decrease the likelihood of false positives (e.g., detecting transmitter signals transmitted by transmitter assemblies positioned on fluid vessels that are not in use), the system 100 can process detected transmitter signals according to one or more rules. Transmitter signals that satisfy the rules can be deemed reliable (or more reliable), and information from those transmitter signals can be recorded by the tracking platform 150. However, transmitter signals that do not satisfy the rules can be deeded unreliable (or less reliable) and can be discarded.

As an example, when activated, the receiver assembly 114 can detect any transmitter signals that are transmitted according to a particular wavelength or range of wavelengths. If only a single transmitter signal is detected, the receiver assembly 114 can determine whether the signal strength of the detected transmitter signal meets or exceeds a particular threshold level. If so, the receiver assembly 114 determines that the detected transmitter signal is sufficiently reliable, and can transmit information from that transmitter signal to the tracking platform 150 for further processing. If the signal strength of the detected transmitter signal is less than the threshold value, the receiver assembly 114 determines that the transmitter signal is not sufficiently reliable, and discards the transmitter signal.

Further, if multiple transmitter signals are detected, the receiver assembly 114 can select the transmitter signal having the highest signal strength from among the detected transmitter signals (e.g., the signal having the highest received signal strength indicator [RSSI], or other signal strength metric). Further, the receiver assembly 114 can determine whether the signal strength of the strongest transmitter signal meets or exceeds a particular threshold level. If so, the receiver assembly 114 determines that the strongest transmitter signal is sufficiently reliable, and can transmit information from that transmitter signal to the tracking platform 150 for further processing. If the signal strength of the strongest transmitter signal is less than the threshold value, the receiver assembly 114 determines that the strongest transmitter signal is not sufficiently reliable, and discards the transmitter signal. All other detected transmitter signals can be discarded, as well.

In some implementations, the threshold value can be determined empirically. For example, experiments can be conducted by positioning a dispensing device in various locations relative to one or more fluid vessels and transmitter assemblies, and recording the signal strength of detected transmitter signals in each of those locations. Using these measurements, a threshold value can be selected that differentiates (i) detected transmitter signals that are transmitted by transmitter assemblies attached to fluid vessels that are attached to the dispensing device, and (ii) detected transmitter signals that are transmitted by transmitter assemblies attached to fluid vessels that are not attached to the dispensing device. This threshold value can be programmed into the receiver assembly 114 to reduce the detection of false positives. In some cases, the threshold level can be periodically calibrated by a user and/or a manufacturer (e.g., to improve the reliability and accuracy of the receiver assembly 114 in different operating environments).

### Example Processes

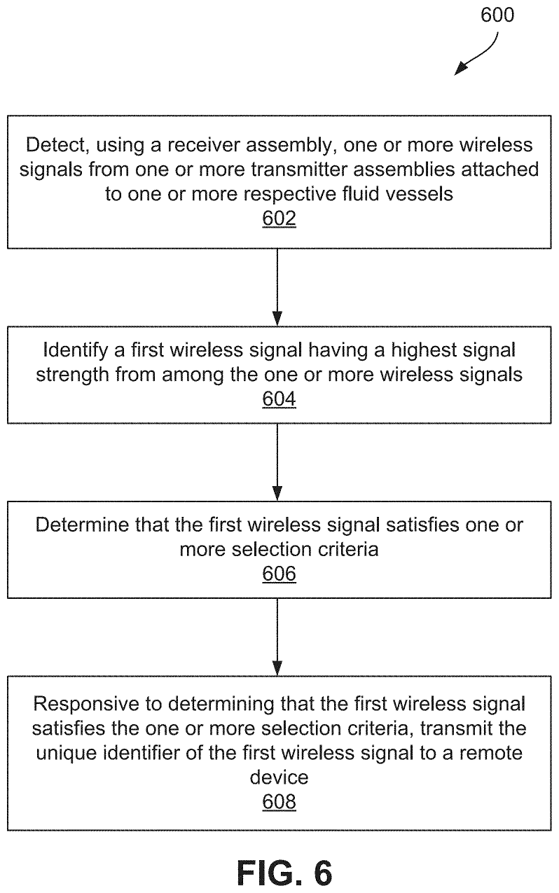

An example process 600 for tracking a fluid vessel (e.g., a beer keg) is shown in FIG. 6. The process 600 can be performed for example, using one or more systems described herein.

In the process 600, one or more wireless signals from one or more transmitter assemblies is detected using a receiver assembly (step 602). Each transmitter assembly is attached to a respective fluid vessel, and each wireless signal includes a respective unique identifier associated with a respective transmitter assembly and a respective fluid vessel. In some implementations, one or more of the fluid vessel can be beer kegs.

Example transmitter assemblies and receiver assemblies are shown and described with respect to FIGS. 1 and 3-5. As an example, referring to FIG. 1, a receiver assembly 114 can detect wireless signal 120a-120c transmitted by transmitter assemblies 118a-118c attached to fluid vessels 116a-116c, respectively.

In some implementations, the receiver assembly is attached to a dispenser for dispensing a substance from at least one of the fluid vessels. Further, the one or more wireless signals can be detected concurrently to a dispensing of the substance from a first fluid vessel by the dispenser. In some implementations, the receiver assembly can be awakened from a low power mode concurrently to the dispensing of the substance from the first fluid vessel by the dispenser.

A first wireless signal having a highest signal strength is identified from among the one or more wireless signals (step 604). In some implementations, signal strength can be represented as RSSI.

A determinant made that the first wireless signal satisfies one or more selection criteria (step 606). In some implementations, the one or more selection criteria can include a requirement that the first wireless signal be greater than or equal to a threshold signal strength. In some implementations, the threshold signal strength can be determined empirically.

Responsive to determining that the first wireless signal satisfies the one or more selection criteria, the unique identifier of the first wireless signal is transmitted to a remote device (step 608). As an example, referring to FIG. 1, the unique identifier can be transmitted to a tracking platform 150 implemented on a remote server computer system 102.

In some implementations, the method can further include generating usage data indicating that the substance has been dispensed from the first fluid vessel by the dispenser, and transmitting the usage data to the remote device. The usage data can include location information indicating a location of the first fluid vessel during the dispensing of the substance from the first fluid vessel by the dispenser. The usage data can include temporal information indicating a time that the substance was dispensed from the first fluid vessel by the dispenser. The usage data can include volume information indicating a volume of the substance dispensed from the first fluid vessel by the dispenser.

In some implementations, the unique identifier of the first wireless signal can be transmitted to a remote device via a network gateway in proximity to the receiver assembly and the dispenser. As an example, referring to FIG. 1, the unique identifier can be transmitted to a tracking platform 150 implemented on a remote server computer system 102 via a gateway 110 in communication with a network 106.

### Example Systems

Some implementations of the subject matter and operations described in this specification can be implemented in digital electronic circuitry, or in computer software, firmware, or hardware, including the structures disclosed in this specification and their structural equivalents, or in combinations of one or more of them. For example, in some implementations, one or more components of the system 100 can be implemented using digital electronic circuitry, or in computer software, firmware, or hardware, or in combinations of one or more of them. In another example, the processes shown in FIG. 6 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

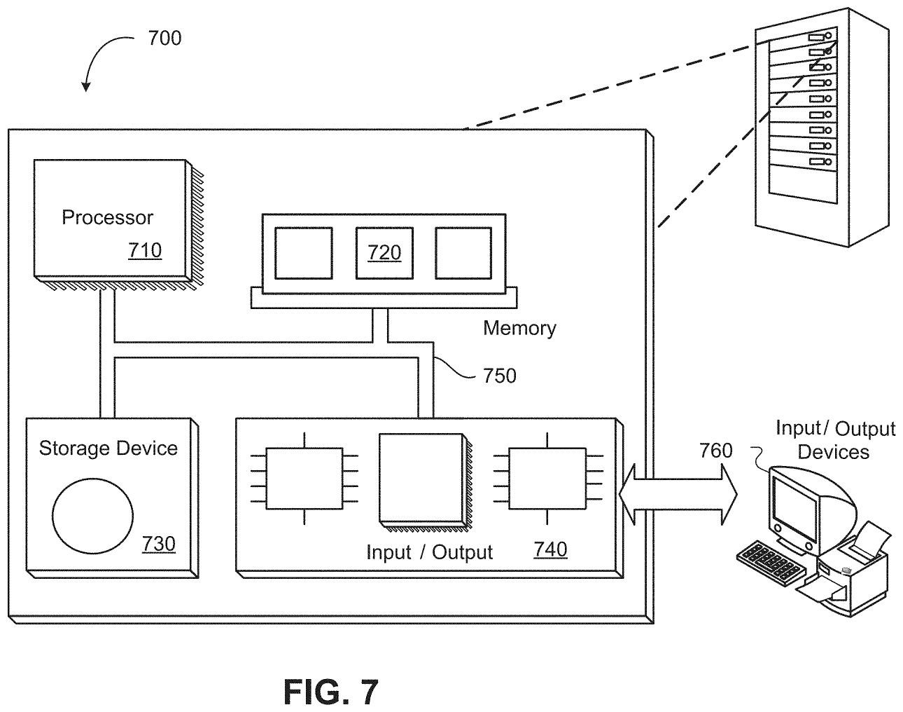

FIG. 7 shows an example computer system 700 that includes a processor 710, a memory 720, a storage device 730 and an input/output device 740. Each of the components 710, 720, 730 and 740 can be interconnected, for example, by a system bus 750. The processor 710 is capable of processing instructions for execution within the system 700. In some implementations, the processor 710 is a single-threaded processor, a multi-threaded processor, or another type of processor. The processor 710 is capable of processing instructions stored in the memory 720 or on the storage device 730. The memory 720 and the storage device 730 can store information within the system 700.

The input/output device 740 provides input/output operations for the system 700. In some implementations, the input/output device 740 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In some implementations, the input/output device can include driver devices configured to receive input data and send output data to other input/output devices, e.g., keyboard, printer and display devices 760. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, various modifications may be made without departing from the spirit and scope of the invention. Accordingly, other embodiments are within the scope of the claims.

What is claimed is:

1. A system for detecting a beer keg, comprising:
a transmitter assembly attached to the beer keg, the transmitter assembly comprising a memory storing a unique identifier for the beer keg, a wireless transmitter for transmitting a wireless signal encoding the unique identifier, and a loop antenna positioned around a mouth of the beer keg;
a receiver assembly attached to a handle for attaching to the mouth of the beer keg, the receiver assembly comprising a reader for reading the wireless signal from the transmitter beacon when the handle is attached to the mouth; and
a data processing apparatus in communication with the receiver assembly and programmed to detect the unique identifier based on the wireless signal read by the reader.

2. The system of claim 1, wherein the handle is rotatable about the mouth and the transmitter assembly is configured so that the wireless signal has a substantially constant signal strength for all positions of the reader in the handle about the mouth.

3. The system of claim 1, wherein the loop antenna is a circular loop.

4. The system of claim 2, wherein the circular loop is centered on the mouth of the keg.

5. The system of claim 1, wherein the loop antenna has a length that is an integer multiple of a wavelength of the wireless signal.

6. The system of claim 1, further comprising a protective cover sealing the transmitter assembly against an outer surface of the keg.

7. The system of claim 1, wherein the transmitter beacon is spaced apart from the loop antenna.

8. The system of claim 1, wherein the wireless signal is a Bluetooth signal.

9. The system of claim 1, wherein the receiver assembly further comprises a wireless transmitter in wireless communication with the data processing apparatus.

10. A transmitter assembly comprising:
an annular support structure;
a wireless beacon secured to the support structure; and
a loop antenna loop secured to the support structure,
wherein the apparatus is configured to attach to a fluid vessel.

11. The transmitter assembly of claim 10, wherein the annular support structure defines a central aperture, and wherein the loop antenna encircles the central aperture.

12. The transmitter assembly of claim 11, wherein the apparatus to configured to attach to the fluid vessel such that the central aperture encircles a mouth of the fluid vessel.

13. The transmitter assembly of claim 10, wherein the wireless beacon is configured to transmit a wireless signal comprising a unique identifier associated with the apparatus.

14. The transmitter assembly of claim 13, wherein the wireless beacon is configured to transmit the wireless signal according to a wavelength of transmission.

15. The transmitter assembly of claim 14, wherein the wavelength of transmission corresponds to a Bluetooth wireless transmission standard.

16. The transmitter assembly of claim 14, wherein the wavelength of transmission is 12.5 cm.

17. The transmitter assembly of claim 14, wherein the loop antenna defines a substantially circular path.

18. The transmitter assembly of claim 17, wherein a circumference of the circular path is substantially an integer multiple of the wavelength of transmission.

19. The transmitter assembly of claim 10, wherein the wireless beacon comprises a beacon antenna, and wherein the antenna is separate and distinct from the loop antenna.

20. The transmitter assembly of claim 19, wherein there is an absence of a conductive trace interconnecting the beacon antenna and the loop antenna.

21. The transmitter assembly of claim 19, wherein a distance between the beacon antenna and the loop antenna is between 0 and 2 cm.

22. The transmitter assembly of claim 10, wherein the fluid vessel is a beer keg.

23. The transmitter assembly of claim 10, wherein the apparatus is integrated into the fluid vessel.

24. A method comprising:
detecting, using a receiver assembly, one or more wireless signals from one or more transmitter assemblies, each transmitter assembly being attached to a respective fluid vessel, and each wireless signal comprising a respective unique identifier associated with a respective transmitter assembly and a respective fluid vessel;
identifying a first wireless signal having a highest signal strength from among the one or more wireless signals;
determining that the first wireless signal satisfies one or more selection criteria; and
responsive to determining that the first wireless signal satisfies the one or more selection criteria, transmitting the unique identifier of the first wireless signal to a remote device.

25. The method of claim 24, wherein the one or more selection criteria comprises a requirement that the first wireless signal be greater than or equal to a threshold signal strength.

26. The method of claim 24, wherein the receiver assembly is attached to a dispenser for dispensing a substance from at least one of the fluid vessels.

27. The method of claim 26, wherein the one or more wireless signals are detected concurrently to a dispensing of the substance from a first fluid vessel by the dispenser.

28. The method of claim 27, further comprising awakening the receiver assembly from a low power mode concurrently to the dispensing of the substance from the first fluid vessel by the dispenser.

29. The method of claim 26, further comprising:
generating usage data indicating that the substance has been dispensed from the first fluid vessel by the dispenser; and
transmitting the usage data to the remote device.

30. The method of claim 29, wherein the usage data comprises location information indicating a location of the first fluid vessel during the dispensing of the substance from the first fluid vessel by the dispenser.

31. The method of claim 29, wherein the usage data comprises temporal information indicating a time that the substance was dispensed from the first fluid vessel by the dispenser.

32. The method of claim 29, wherein the usage data comprises volume information indicating a volume of the substance dispensed from the first fluid vessel by the dispenser.

33. The method of claim 24, wherein the unique identifier of the first wireless signal is transmitted to a remote device via a network gateway in proximity to the receiver assembly and the dispenser.

34. The method of claim 24, wherein one or more of the fluid vessels are beer kegs.
